(19) United States
(12) Patent Application Publication
(10) Pub. No.: US 2026/0054306 A1
(43) Pub. Date: Feb. 26, 2026

(54) DEVICE AND METHOD FOR LOADING OR UNLOADING A SHEET METAL PROCESSING MACHINE OR A WOOD WORKING MACHINE

(71) Applicant: ARKU MASCHINENBAU GMBH, Baden-Baden (DE)

(72) Inventors: Jacques BURTSCHER, Rountzenheim-Auenheim (FR); Abdessamad AMYAY, Baden-Baden (DE)

(73) Assignee: ARKU MASCHINENBAU GMBH, Baden-Baden (DE)

(21) Appl. No.: 19/297,337

(22) Filed: Aug. 12, 2025

(30) Foreign Application Priority Data
Aug. 20, 2024 (EP) 24195323.1

(51) Int. Cl. B21D 43/10; B27C 1/12

(52) U.S. Cl. CPC B21D 43/105; B27C 1/12

(57) ABSTRACT

A device for loading or unloading sheet metal processing or wood working machine, including: sensor interface that receives information on workpieces in a loading area; representation unit for creating representation of workpieces and loading area, based on sensor signal; user interface for providing representation to machine operator and for receiving user input from machine operator including information on position of workpieces in representation; evaluation unit for determining revised representation of workpieces and loading area, based on sensor signal and user input, interface being designed for providing revised representation to machine operator and for receiving further user input including information on workpiece loading operation carried out; planning unit for determining control instructions enabling loading robot to execute loading operation being carried out based on signal and on further user input; and control interface for activating and controlling loading robot to execute loading operation based on control instructions.

The present invention relates to a device and a method for loading or unloading a sheet metal processing machine or a wood working machine. The present invention further relates to a system for loading or unloading a sheet metal processing machine or a wood working machine and an associated computer program product.

The production or processing of sheet metal products often leads to stresses occurring in the metal sheet or to bending of the sheet. In order to reduce these undesirable effects, leveling machines, in particular roller leveling machines, are employed to process such sheet metal workpieces. When cutting and punching parts made of sheet metal, the cutting edges and rims of the cut-out apertures and recesses will form unwanted burrs protruding from the top or bottom surface of the steel sheet. In particular, sheet steel parts having a thickness of several centimeters may require a great deal of technical effort to deburr them, i.e. to round the edges and grind the surface.

Notably, such sheet metal processing machines, but also machines in the field of wood working, are usually operated in a pass-through mode. The workpieces to be processed arrive on a pallet or on another type of load carrier, are deposited on a transport belt, and are fed to the machine for processing. Once the processing operations have been accomplished, the workpieces are again deposited on a load carrier.

To increase the efficiency of such working steps, automated approaches have been developed in which workpieces are grasped by robots and are, for example, transferred from one processing station to a subsequent station within the materials processing machine. Likewise, there are approaches aimed at providing both, automated loading and unloading.

In this context, DE 10 2018 218 828 A1 discloses a method and system for modifying a manufacturing process in a machine plant and/or a virtual 3D model of said machine plant. The method is designed for being employed in a real-world machine plant having at least one machine, which is especially programmable and may, in particular, be a robot, and/or is designed for being employed in a virtual 3D model of said machine plant. The method comprises the steps of: acquiring machine plant signals while the manufacturing process is being executed in the machine plant; storing given points in time together with associated machine data based on the acquired machine plant signals; determining position, movement, and/or status data of at least one object of the virtual model for at least one particular time in the past based on said stored points in time and their associated machine data; and representing and/or virtually measuring the virtual model of the machine plant based on the determined position, movement and/or status data.

However, the operations of depositing the workpieces onto the transport belt and of picking the workpieces from there once processing is accomplished is still often carried out manually, particularly so when relatively small numbers of units per lot are to be processed. For many applications, the expenditure required to set up and/or teach-in or calibrate such an automated solution is greater than its benefit.

With this in mind, the present invention has the object of providing an approach for efficiently loading and unloading a sheet metal processing machine or a wood working machine. The object to be achieved is to provide both high throughput and low susceptibility to errors, while at the same time keeping the requirements for teaching-in and for the necessary technical implementation low. The object of the invention is to provide approach which can be carried out in a cost-effective manner and which, nevertheless, enables a great increase in efficiency.

To achieve this object, the present invention, in a first aspect, relates to a device for loading or unloading a sheet metal processing machine or a wood working machine, including:
a sensor interface for receiving a sensor signal comprising information on workpieces in a loading area of the sheet metal processing machine or wood working machine;
a representation unit for creating a representation of the workpieces and of the loading area, based on the sensor signal;
a user interface for providing said representation to a machine operator and for receiving a user input from the machine operator comprising information on a position of the workpieces in the representation;
an evaluation unit for determining a revised representation of the workpieces and the loading area, based on the sensor signal and on the user input, the user interface being designed for providing said revised representation to the machine operator and for receiving a further user input comprising information on a workpiece loading operation to be carried out;
a planning unit for determining control instructions enabling a loading robot to execute the loading operation to be carried out based on the sensor signal and on said further user input, and a control interface for activating and controlling the loading robot to execute the loading operation based on the control instructions.

In a further aspect, the present invention relates to a system for loading or unloading a sheet metal processing machine or a wood working machine, including:
a device as described above;
a sensor for covering the loading area; and
a loading robot for executing the loading operation based on the control instructions, in particular an industrial robot having a manipulator arm.

Further aspects of the invention relate to a method that is designed to correspond to said device and to a computer program product having program code for carrying out the steps of the method when the program code is being executed on a computer, and to a storage means on which a computer program is stored which, when executed on a computer, causes the method described herein to be performed.

Preferred configurations of the invention will be described in the dependent claims. It is to be understood that the features mentioned above and those yet to be explained further down may not only be used in their respectively specified combination but also in other combinations or alone without departing thereby from the scope of the present invention. In particular, the device, the system, the method, and the computer program product may be designed so as to correspond to the configurations as described for the device and the system in the dependent claims.

According to the invention, an automation of the loading and/or unloading processes is provided which takes into account an intervention of the machine operator at two points. A current situation in a loading zone and/or in an unloading zone (loading area) is acquired via a sensor. More precisely, workpieces (sheet metal parts or wooden parts) present in the loading area are detected. These workpieces may, for example, be disposed on a pallet or on another load carrier. A plurality of workpieces, in particular workpieces of the same type, may (respectively) be stacked so as to lay one atop another. Advantageously, the orientation of the workpieces within the stack is identical. The workpieces themselves are preferably planar or flat parts. It is possible, for example, to process parts with a weight ranging between a few hundred grams and up to 20 kg or more and with an extension of between a few square centimeters and a few square decimeters or more. Notably, irregularly shaped sheet metal parts can be processed as workpieces.

Based on the sensor signal, a first step consists in creating a representation of the workpieces and of the loading area. This representation is provided to the machine operator who then proceeds to a selection of the workpieces on the basis of said representation. This selection is received in the device via a user input. Through the selection, the user indicates the positions within the representation in which the workpieces are located. The user input then serves as a basis for the automated revision of the representation.

In a second step, the revised representation is provided to the machine operator. Via a further user input, the machine operator provides information on a loading operation of a workpiece that is to be carried out. He or she may specify, in particular, the manner in which the workpiece is to be grasped and to which location it needs to be transferred for carrying out the loading operation. Upon loading the machine, it is thus possible, in particular, to indicate a loading position, and upon unloading, an unloading position of the workpiece may be indicated. Upon loading it is possible, in particular, to give a positional indication with respect to the through-feed width of the machine.

Proceeding from this further user input, the loading operation to be carried out may be planned, i.e. the control instructions for the loading robot may be determined and the loading robot may then be activated and controlled to perform the loading operation. In particular, an industrial robot including an appropriate manipulator arm and an appropriate gripping device may thus be activated and controlled.

Compared to prior art approaches, with manual loading and/or unloading of the workpieces, the approach according to the invention enables a gain in efficiency. This makes it possible to largely automize the loading and thus to save on personnel expenditure. Efficiency advantages will result therefrom. The intervention of the machine operator is only necessary for specifying the two user inputs. The intervention of the machine operator occurs upstream of the processing. This may result in a somewhat longer make-ready time. The loading operation, on the other hand, may then be performed in an automized manner by a loading robot and without any further intervention of the machine operator.

Compared to a full automation, including, for example, an image acquisition of the workpieces, the grasping position, and the depositing position, the approach according to the invention enables enhanced safety and improved efficiency. In particular, it is possible to reduce the expenditure for monitoring the loading area (required sensors, etc.) as well as the expenditure for the automated processing of the acquired sensor data (utilization of automated data processing solutions, etc.). Moreover, additional machine protection devices for error prevention may be dispensed with. Furthermore, no complex and demanding teach-in and calibration operations are necessary. The robot does not need to be subjected to detailed training in an extensive teach-in and/or calibration operation in order to be able to receive clear specifications regarding the picking and depositing of workpieces. By taking into account two user inputs, an automation of the loading job may be achieved which allows an efficient processing, particularly in the case of relatively low lot numbers and high degrees of freedom regarding the shaping of the workpieces.

In a preferred configuration, the sensor interface is designed for receiving a sensor signal related to a color image (optionally: a monochrome image) and to a depth image of the workpieces present in the loading area. In particular, the sensor signal may be received from one, two, or more cameras. These cameras are directed towards the loading area. By using a color camera and a depth camera, different sources of information may be provided whose signals may be advantageously combined at a later stage. Besides, such combined camera and depth camera systems are technically advanced and are readily available at a low cost. Furthermore, generally available and highly developed image processing algorithms may be used which provide a low susceptibility to errors. The result is a high degree of efficiency at a low cost.

In a preferred configuration, the evaluation unit is designed for creating an image representation. Notably, when a signal from a camera is received via the sensor interface, this may be used to create an image representation which may be provided to the machine operator. For this purpose, processing steps such as an adaptation of contrast and/or brightness may be provided. However, more complex processing operations such as a coordinate transformation may also be performed. The representation is provided to the machine operator, enabling the latter to efficiently provide a user input. The utilization of an image representation, in particular, has the advantage that even untrained machine operation personnel, or personnel that is in this respect untrained, can intuitively develop a comprehension of the representation and provide an appropriate user input.

In a preferred configuration, the user interface comprises a display, in particular a touchscreen display. A touchscreen display ensures an easy and efficient possibility to display the representation and to receive the user input. The operation is thus intuitive. Extensive training sessions and/or a lengthy familiarization of the machine operator can be avoided. In addition, the error susceptibility is reduced.

In a preferred configuration, the user interface is designed for receiving a further user input comprising a position of a grasping point for the loading robot on the workpiece. Additionally or alternatively, the user interface is designed for receiving a further user input comprising a depositing position of the workpiece. Additionally or alternatively, the user interface is designed for receiving an orientation of the workpiece when it is being deposited. The grasping point here is to be understood as relating to the point or the area or the plurality of points on the workpiece at which the latter is contacted when being grasped. Depending on the grasping system of the loading robot (one point or a plurality of points at which the workpiece is being contacted, magnetic grasper, etc.), the position of the grasping point is therefore to be understood in particular as the orientation of the grasping system with respect to the workpiece. A depositing position of a workpiece refers to the point at which the latter is deposited for further processing when a loading operation is considered, or to the point at which it is deposited for storing/further processing/further transportation when an unloading operation is considered. An orientation of the workpiece refers to the three-dimensional or two-dimensional position of the latter when being deposited. This further user input may, in particular, also be received via a touch on a touchscreen display. Obviously, other means of user input are also possible. Said further user input may also comprise a plurality of appropriate items of information. The result is a high degree of usability. The required process parameters can be specified in a simple manner.

In a preferred configuration, the evaluation unit for determining a surface plane of a workpiece is designed for being based on a segmentation and for being based on a user input. For this purpose a RANSAC algorithm (random sample consensus algorithm) may notably be employed. In addition, or alternatively, the evaluation unit is designed for determining an orthographic view. Image data provided by a color camera and image data provided by a depth camera can both be subjected to segmentation. Notably, a segmentation based on color image data may be provided. In other words, proceeding from a simple user specification and/or user selection, in which for example a single point that belongs to the workpiece is specified by the machine operator, an efficient recognition of a workpiece is enabled. Proceeding from this recognition an orthographic view may then be established. An orthographic view is to be understood, in particular, as a view in which all parts of the workpiece will appear in the same scale, thus enabling a simple evaluation of the relative dimensions and of the orientation of the workpieces. More specifically, a perspective view provided by a sensor directed towards the loading area is converted into an orthographic view, which allows the machine operator to obtain an enhanced and efficient evaluation of the workpieces as a basis for specifying the loading operation to be carried out. The result is an efficient processing.

In a preferred configuration, the planning unit is designed for determining control instructions comprising grasping coordinates and depositing coordinates of the workpiece. In particular, 6D coordinates (position and orientation) may be determined. The path planning may then be effected based on predetermined standard approaches. In addition, appropriate transformations may be effected. The result is an efficient processability.

In a preferred configuration, the planning unit is designed for determining control instructions comprising predefined path default data for the movement of the loading robot related to the loading area. Said path default data has preferably been determined in the course of a calibration process. Additionally or alternatively, the planning unit is designed for determining control instructions comprising predefined sensor position data for the position of the sensor related to the loading area. Said sensor position data has preferably been determined in the course of a calibration process, preferably carried out during a start-up procedure. The inclusion of path default data may, in particular, correspond to an inclusion of data relating specifically to the loading area. In particular, it is possible in a one-time operation to be carried out during the installation of the loading area, to determine the manner in which the loading robot may move within the loading area, thus defining which types of movement are possible and/or advantageous. This default specification may be a one-time operation. This data may be taken into account during the setup/initialization of the individual loading operation according to the invention. It is thus not necessary for each individual loading operation of a plurality of parts to carry out a corresponding calibration. A one-time calibration, to be carried out, for example, during start-up, will be sufficient for making it possible to subsequently load various types of workpiece. The same holds true accordingly for the sensor position data. These sensor position data describe in particular a position as well as an orientation of the sensor with respect to the loading area. Notably, the orientation and position of a camera may be defined in a one-time operation as the sensor position data and may then be taken into account during the planning jobs to be effected in the planning unit. This results in a further efficiency enhancement since the path default data as well as the sensor position data need to be determined only once and may subsequently be utilized in various different loading operations.

In a preferred configuration, the user interface is designed for receiving a user input comprising a thickness of the workpieces. In particular in cases where workpieces are stacked, or are to be stacked, the additional input of their thickness constitutes an advantageous item of additional information. Given said thickness, an appropriate activation and control of the loading robot can be enabled. It is, for example, not necessary for this thickness to be acquired by additional sensors. A further efficiency enhancement may therefore be achieved. Costs can thus be reduced. Usually, parts having an identical contour will also be identical in thickness. Should this not be the case, their thickness may also be acquired by an appropriate sensor arrangement.

In a preferred configuration, the user interface is designed for receiving a user input comprising information on a position of workpieces that are located in the representation in an uppermost one of a plurality of layers of workpieces. The planning unit is designed for recognizing an offset of a workpiece that is located in a second layer, subsequent to a loading operation of a workpiece having been deposited in a first layer. The planning unit is designed for determining the control instructions on the basis of said offset. It is thus possible, in particular, to process also workpieces that are stacked. Workpieces may, for example, be supplied in stacks that are placed on a pallet. The machine operator selects the position of a workpiece placed in an uppermost layer. Proceeding from this indication, an automated processing of the entire stack of workpieces can be effected, once the offset has been determined. It is particularly advantageous if, in addition, the thickness of the workpieces is available as a further item of information.

In a preferred configuration of the system according to the invention, the sensor comprises a color camera and/or a depth camera directed towards a loading area of the sheet metal processing machine or the wood working machine. The utilization of cameras of this type enables an efficient implementation at a relatively low cost. In addition, it is possible to employ standard image processing approaches which enable a high degree of efficiency.

In a preferred configuration of the system, the loading robot is designed for carrying out a loading operation. The sensor is designed for covering a loading area. The system comprises another loading robot for carrying out an unloading operation. The system further comprises another sensor for covering an unloading zone and for providing a sensor signal comprising information on workpieces present in the unloading zone. The planning unit is designed for determining control instructions enabling the other loading robot to execute an unloading operation to be carried out based on the sensor signal, the further sensor signal, and the further user input. The control interface is designed for activating and controlling the other loading robot to execute the unloading operation based on the control instructions. In addition to the loading robot, another loading robot is employed. The loading robot thus serves for loading the sheet metal processing machine or the wood working machine, while the other loading robot serves for the purpose of unloading. Said other sensor covers the unloading zone. According to the invention, the workpiece-specific information acquired in relation with the loading process will notably also be used for the unloading operation. It is possible, for example, to create a mesh model of the workpiece on the basis of the user input and the further user input entered during the loading operation. This mesh model or any other information may subsequently, upon unloading the machine, be provided to the other loading robot or may be taken into account for its activation and control. The result is an even more enhanced efficiency.

A sheet metal processing machine or a wood working machine is to be understood here as a machine for processing individual parts having a size that allows them to be handled by means of an industrial robot. In particular, workpieces delivered on pallets or similar load carriers are to be processed. Notably, workpieces having different contours and/or different shapes are to be processed. In one process step, several identical workpieces are to be processed. In the subsequent process, however, workpieces having another shape will have to be processed. A representation is to be understood as referring in particular, but not exclusively, to an image representation and/or a pictorial representation. An industrial robot or a loading robot refers in particular to an industrial manipulator or a robot having a manipulator arm designed for handling workpieces. A loading area is to be understood here in particular as an area adjoining and/or surrounding a sheet metal processing machine or a wood working machine. The loading area comprises a floor space for accommodating a load carrier and/or an area for depositing workpieces. The loading area also comprises the incoming area and/or the outgoing area of the machine (machine in-feed area and machine out-feed area). Both of them, a loading zone and an unloading zone, may equally be referred to as a loading area. In its narrower sense, however, the latter term may be employed as a synonym of loading zone.

The approach according to the invention may also enable a user input relating to an orientation of the workpieces in a grinding or leveling operation. A grinding operation typically leads to a defined grinding pattern in one direction. The machine operator may thus specify a given orientation of the grinding pattern when the workpiece is deposited. Upon leveling, the operator can select the orientation depending on the orientation of the bow or bulge in order to flatten it in a controlled manner.

The contours and grasping points entered by the machine operator can be stored. It is thus possible to establish a database comprising workpieces, grasping points and orientations as well as associated machine settings (such as employed abrasives, abrasive feeds, abrasive speeds, alignment gap adjustments, conveyor belt speed, etc.). For recurring jobs, this data may be retrieved and the make-ready time can thus be reduced. For example, recognized workpieces may be suggested to the machine operator in the form of images and, if applicable, may then be confirmed by the latter. Furthermore, it is possible to establish a recipe associated with the load carrier. In the case of recurring load carriers, this recipe can then be retrieved and re-enacted.

It is possible to employ a plurality of grasping systems. The grasping system may be changed automatically via a magazine. Different workpiece geometries can thus be safely grasped. It is possible that a grasping system is represented in the user interface. If the grasping system comprises a plurality of grasping points, the positions of the individual grasping points on the workpiece can, where applicable, be indicated to the machine operator. The operator may then, if necessary, position the grasping points in such a manner that they (in their majority) are not placed at an open location (i.e. a hole) of the workpiece in order to ensure that the latter will be safely grasped. If the workpiece cannot be safely grasped in this manner, the machine operator may select another grasping system which better matches the workpiece to be grasped.

Where non-flat workpieces are involved, the part's surface may, if required, be re-calculated for each workpiece.

When the machine operator is about to enter the loading position, a visualization of the nearest workpiece in the stack may be indicated to him on the basis of the known conveyor belt speed. Starting from the surface of the workpieces and from the stack heights, it is possible to determine a wear distribution along the machine width. The wear distribution may be indicated to the machine operator. Based on this distribution, the machine operator may specify an equal distribution in order to achieve a uniform wear of the abrasive in a grinding machine and/or a uniform wear of the leveling rollers in a leveling machine. Optionally, an ideal loading position may be proposed to the machine operator.

In a preferred configuration, workpieces having an identical contour are stacked atop one another on the load carrier. In a captured image, all the possible contours are identifiable. There are no covered portions and/or no initially covered contours. Once the make-ready operation has been accomplished, the machine operator can leave the plant and the workpieces can be processed in an automated manner.

In the following, the invention will be described and explained in greater detail with reference to a few selected embodiment examples and in connection with the enclosed drawings. In the drawings:

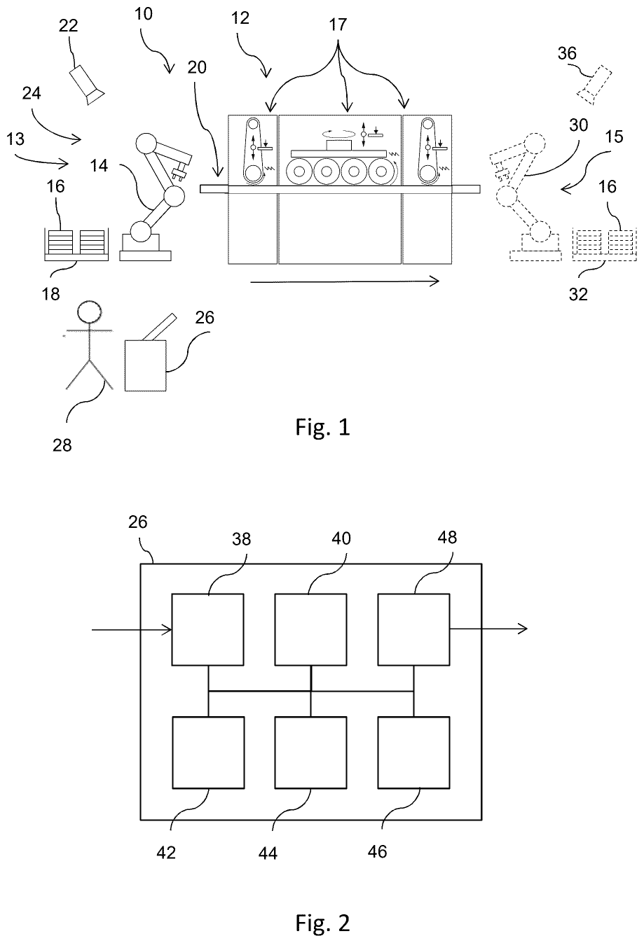

FIG. 1 is a schematic representation of a system according to the invention for loading or unloading a sheet metal processing machine or a wood working machine;

FIG. 2 is a schematic representation of a device according to the invention;

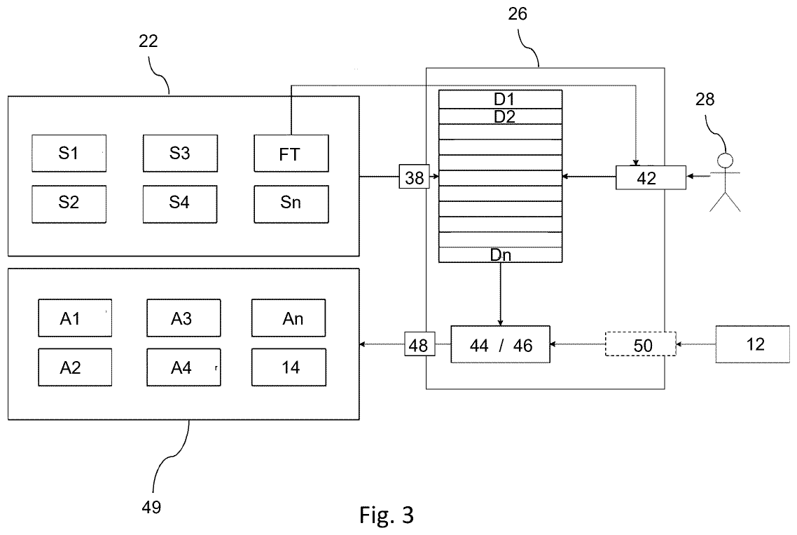

FIG. 3 is a schematic representation of the data flows and of the interaction of the machine operator with the inventive system according to one embodiment;

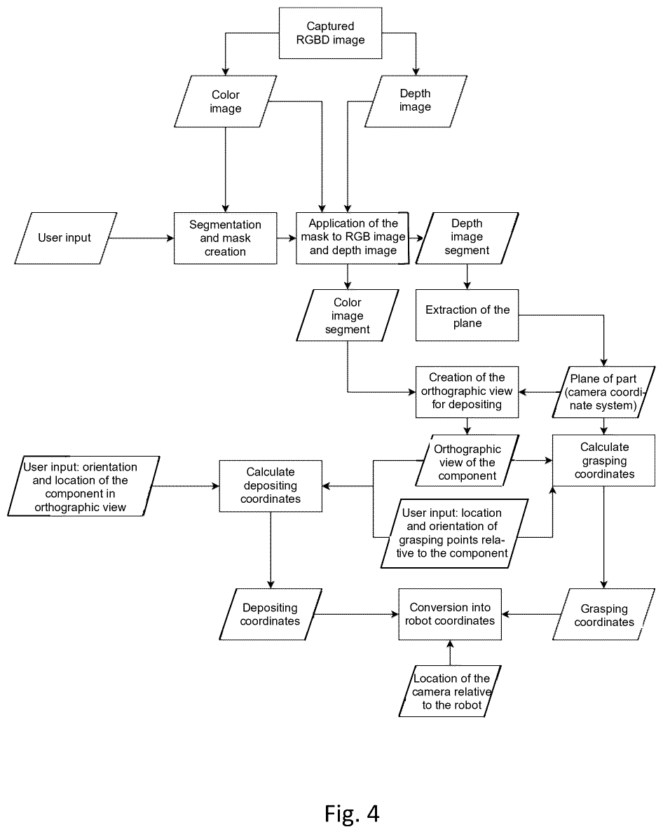

FIG. 4 is a schematic representation of the procedure of the inventive approach according to one embodiment;

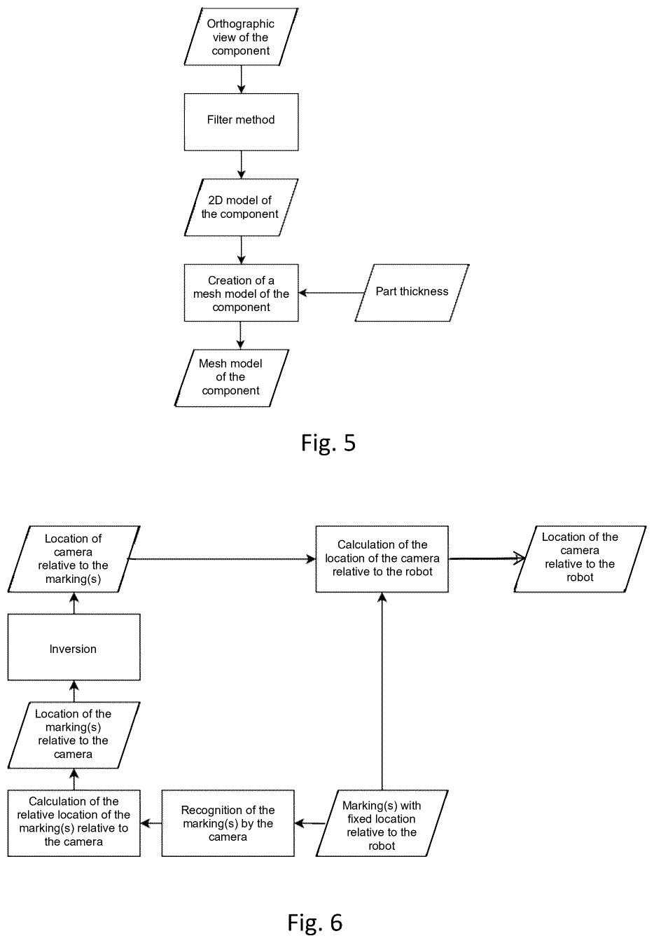

FIG. 5 is a schematic representation of an optional modification of the procedure of the approach according to the invention;

FIG. 6 is a schematic representation of an optional modification of the approach according to the invention; and

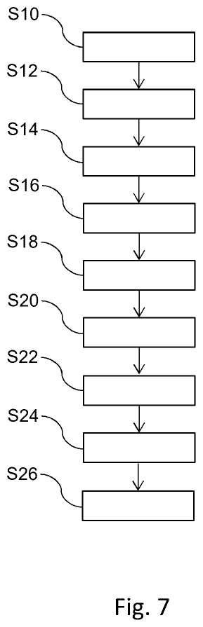

FIG. 7 is a schematic representation of a method according to the invention.

FIG. 1 schematically represents a system 10 according to the invention for loading or unloading a sheet metal processing machine or a wood working machine 12. The schematic representation shows in particular a sheet metal processing machine, notably a deburring machine. The sheet metal processing machine or wood working machine 12 is operated in a pass-through mode. The machine is, in particular, provided with a transport belt that serves for conveying the workpieces 16 from the loading zone 13 to the unloading zone 15. In the sheet metal processing machine or wood working machine 12, processing takes place at one (or several) processing stations 17. The system 10 comprises a loading robot 14 which is designed to convey workpieces 16 from a load carrier 18 to an incoming area 20 of the sheet metal processing machine in the course of a loading operation. The workpieces 16 may notably be placed in a stacked condition on the load carrier 18 when they are supplied to the machine. The system 10 further comprises a sensor 22, in the illustrated embodiment example a camera sensor, that is designed to cover a loading area 24 (in the illustrated embodiment example notably a loading zone). Furthermore, the system 10 comprises a device 26 that interacts with the sensor 22 and with the loading robot 14. In the illustrated embodiment example, the device 26 is an industrial computer which is used by a machine operator 28.

The approach according to the present invention relates in particular to a partial automation of the loading and/or unloading operation(s) of a sheet metal processing machine or a wood working machine. The object is in particular to achieve an efficient and easily implementable partial automation by deliberately incorporating some user input.

The illustrated embodiment example shows an (optional) embodiment of the system 10 in which another loading robot 30 is provided. This other loading robot 30 withdraws the workpieces 16 from the transport belt of the sheet metal processing machine or wood working machine 12, once they have been processed. The workpieces are subsequently deposited in another load carrier 32. The unloading zone 15 is covered by another sensor 36. A sensor signal is created which contains information on the workpieces 16 present in the unloading zone 15. Via this optional complement, data that has been acquired during loading may be re-used for the unloading operation.

FIG. 2 schematically represents a device 26 according to the invention for loading or unloading a sheet metal processing machine or a wood working machine. The device 26 comprises a sensor interface 38, a representation unit 40, a user interface 42, an evaluation unit 44, a planning unit 46 as well as a control interface 48. The various units may be partially or fully implemented in software and/or hardware. In particular, the units can be designed as a processor, as processor modules or in the form of software for a processor. The device 26 may, for example, be implemented in the form of an industrial computer. It is also possible that the device and/or the method carried out using said device are designed in the form of software for a machine system of a sheet metal processing machine. The functionality of the device 26 may, for example, be implemented in software, said software being executed on a machine system of a sheet metal processing machine. However, it is also possible for the device 26 to be designed as an additional device that is connected, in a wired or wireless manner, to a machine system of the sheet metal processing machine, a loading robot, and to corresponding sensors.

The sensor interface 38 is connected to the sensor, which sensor may comprise, in particular a color camera and a depth camera. It is thus possible to receive a color image and a depth image of the workpieces present in the loading area and of the entire loading area.

The representation unit 40 serves for creating a representation of the workpieces and of the loading area, based on the sensor signal. On the basis of said sensor signal, a representation, in particular an image and preferably a live image, is created that can be assessed by a machine operator. The representation unit 40 may either simply transmit the received image or may perform image processing operations.

The user interface 42 is designed for allowing interaction with the machine operator. The user interface 42 may, in particular, comprise a touchscreen display. The utilization of another type of display is also possible. The user interface 42 enables an interaction with the machine operator. The machine operator may, in particular, enter data and read and/or receive a data output. The representation may notably be displayed. The displayed representation may, in particular, be an image representation. On the basis of said image representation, the machine operator may then enter and/or select positions of the workpieces in the representation. The machine operator may, in particular, select a given point on a workpiece. This job may be carried out via a touch input (clicking on an object). In particular, the machine operator selects one workpiece per stack of workpieces (the uppermost one), respectively, or, more precisely speaking, selects a given point for each uppermost workpiece. Thus a technically demanding image data processing operation and an automated recognition of workpieces can be avoided. This leads to a considerable simplification, since otherwise demanding teach-in operations and/or evaluation processes would be necessary, especially for complex workpiece shapes.

The evaluation unit 44 determines, based on the user input provided by the machine operator, a revised representation of the workpieces and of the loading area. For this purpose, both the user input and the sensor signal are used/evaluated. Notably, a surface plane of the workpiece or the workpieces can thus be determined. This may be done in particular by using a segmentation. For this purpose, a RANSAC algorithm may be employed. This is to say that on the basis of the input defining one point of the workpiece the entire contour of the workpiece is being determined. In addition, it is possible to create an orthographic view of the workpiece. Such a view is to be understood, in particular, as a scale view in which all kinds of perspective distortion have been eliminated. This is particularly advantageous if, for example, an obliquely-mounted camera is used for capturing the image, if on this image the workpieces are selected by the machine operator and subsequently some further processing is to be effected.

Once the revised representation has been determined, said revised representation is fed back, via the user interface 42, to the machine operator. By means of a renewed user input, the latter provides information on a loading operation of the workpiece that is to be carried out. In particular, the further user input consists in defining a position of a grasping point for the loading robot on the workpiece. Depending on the type of workpiece, a grasping point or point of engagement may be defined in such a manner as to ensure that the workpiece can be efficiently grasped and fixed on the manipulator arm of the loading robot.

Incorporating data input by a machine operator makes it possible to rely on the experience of the latter. In particular, the machine operator manually defines the way in which the workpiece is to be grasped, so that a more demanding data processing procedure can be avoided.

In addition, said further user input may comprise a depositing position of the workpiece. Notably, the depositing position may be specified within a depositing area, in particular on a transport belt of the wood working machine or the sheet metal processing machine. Thus disposing, for example, of a stored image of the loading area, the machine operator may specify, through a graphical visualization, an appropriate depositing position. The machine operator will thus preset the depositing position. Obviously, a further degree of automation may, for example, consist in that, sequentially, different/varying depositing positions are preset in order to make use of the entire width of the transport belt. Furthermore, it is advantageous if the machine operator specifies an orientation of the workpiece when it is being deposited. The crucial point here is, in particular, the orientation in which the workpieces are to be supplied to the machine. In all cases, the data entered by the machine operator when carrying out said further user input may replace a comparatively more demanding data processing procedure, thus leading to a gain in efficiency.

The planning unit 46 serves for determining control instructions for the loading robot. This is based on the further user input and on the sensor signal. This data is the basis for determining the way in which the loading robot inserts the workpiece into the sheet metal processing machine or wood working machine 12. Notably, appropriate grasping coordinates and depositing coordinates may be determined. For this purpose, an appropriate conversion is effected. The planning may optionally be based on the utilization of path default data. Such path default data serves for specifying default values relative to the loading area. Such default values may be, for example, waypoints along the path of the loading robot. In addition, travel directions and travel speeds may also be preset. These path default data may, for example, be stored in memory when the system according to the invention is put into operation and may as such reflect particularities of the current operation site and/or robotic cell. Furthermore, sensor position data may also be taken into account correspondingly. These reflect the sensor position, i.e. the position and orientation of the sensor with respect to the loading area. Also the sensor position data are application case specific and/or application area specific and need to be stored only once, for example when the inventive device and/or the inventive system are put into operation at a given operation site. On this occasion, both the path default data and the sensor position data may be determined in one calibration operation.

For example, the uppermost workpiece in the stack is selected by the machine operator. This selected part will not be present in the image once it has been grasped. The captured/determined geometry (contour) of this part and the grasping position may then be used, in particular, for the two following purposes:
recognizing and grasping the part once the processing is accomplished in order to unload it; and
recognizing and grasping the following part in the stack.

In the case of a load carrier comprising several identical parts it is possible to search the image for the selected part or its contour and, in this way, to recognize it also in other stacks. The indicated grasping position may then be transferred to the other stacks.

The user interface 42 may, in addition, be designed for receiving a thickness of the workpieces. This is advantageous, in particular, in cases in which the workpieces to be processed are supplied in a stacked disposition. The specification of the thickness of the workpieces by the machine operator makes it possible to achieve a further simplification. The object thus achieved is in particular that the loading robot can travel at a comparatively high speed to the appropriate grasping position without the danger of having to intercept a collision. Notably, it is possible, via the user interface 42, to receive positions of identical workpieces lying atop one another in several layers.

The control interface 48 serves for activating and controlling the loading robot. In particular, an industrial robot including a manipulator arm may thus be activated and controlled.

The approach according to the invention is aimed at automizing, or rather partly automizing, the loading and unloading operations in sheet metal processing machines and in wood working machines. In particular, the system according to the invention serves for transferring sheet metal parts in the machine in-feed area from a load carrier to a conveyor belt of said processing machines. Additionally, the sheet metal part may be withdrawn again from the conveyor belt at the machine out-feed area and deposited onto the load carrier.

Essentially, the process of loading workpieces onto a machine, or rather onto a handling system connected to a machine, requires information on the location of the workpieces that need to be loaded and on the points that need to be navigated to and/or grasped by the loading system and/or the loading robot. These grasping coordinates may either be retrieved (predefined layers on a pallet: “recipes”), determined (AI camera systems: generative grasping point determination on unknown parts or part recognition and retrieval of stored grasping points on the part), or conveyed in a learning process (teaching-in: defining points to be navigated to by activating and controlling the robot to perform the appropriate operation). The depositing points may be established accordingly via generative coordinate creation, predefined coordinates, or a teaching-in procedure. These grasping points may then be used for planning the travel path of the loading robot.

The approach according to the invention enables a simplification and a reduced error susceptibility as well as an enhanced robustness, particularly with changing ancillary conditions (e. g. lighting conditions). Teach-in operations may also lead to considerable expenditures. The approach according to the invention involves the machine operator at two stages of the process and, by taking into account his or her input, brings about an enhanced robustness while at the same time considerably reducing the expenditure. What is essentially proposed is to combine or couple AI models with the intelligence of the machine operator in order to reduce the expenditure. With some degree of user input by the machine operator a partial automation may thus be achieved.

FIG. 3 in this context is a representation of the approach according to the invention. What is shown here, in particular, is that a machine operator 28 interacts with the device 26 according to the invention via a user interface 42. Via a sensor interface 38, the device can receive data from a sensor 22. The data items D1 . . . Dn received via the user interface 42 and the sensor interface 38 may concern/comprise, for example, a grasping point, a number of workpieces present in a stack, an orientation of the part, a start/stop of the machine, a necessity to turn the parts over, a necessity to provide interim storage space, a double metal sheet recognition, a depositing point, a metal sheet thickness as well as other items of information. The sensor 22 may notably comprise a combined color image and depth camera. In addition, the sensor may also comprise further data sources S1 . . . Sn, such as a double metal sheet sensor, a metal sheet thickness sensor, a force sensor, and a grasping sequence sensor as well as other sensors. The evaluation unit 44 serves for processing these different types of data. In the planning unit 46 the loading operation is being planned. In the illustrated embodiment example, the evaluation unit 44 and the planning unit 46 are jointly implemented. The planning unit 46 is connected to the loading robot 14 via the control interface 48. Further systems/actuators A1 . . . An may also be connected. For example an activation and control of the handling system, of a turning unit, a slip sheet remover, a grasper magazine, a double metal sheet separator or other units may also be provided. The sheet metal processing machine or wood working machine 12 may also be connected to the evaluation unit and/or planning unit via an (optional) machine interface 50.

According to a preferred configuration of the inventive approach, provision is made for a color image and a depth image of a pallet and of the workpieces placed thereon to be taken by a combined color and depth camera. Subsequently, the machine operator, in a first step, will define the position within the image and/or the location of the workpiece via a user input. This input may then be used for the purposes of segmenting the color image and generating a mask. An image mask is created which comprises exclusively the workpiece.

This image mask may then be applied to both the depth image and the color image. The resulting depth image segment may be used for extracting the surface plane of the component. Since a sensor signal from a depth camera often contains a relatively high proportion of noise, an application of a RANSAC algorithm will be advantageous. The color image segment is used in combination with the data of the plane to eliminate the perspective distortion, thus creating an orthographic view of the component. The grasping points may be defined either before or after the creation of the orthographic view. This may be done, in particular, through a further user input by the machine operator. A visualization of the grasper in the orthographic view of the workpiece facilitates the process for the machine operator, thus enabling even an inexperienced machine operator to efficiently use the approach according to the invention. The orthographic view makes it possible to define the orientation of the component being deposited as well as the depositing point. Owing to the absence of perspective distortion, an orthographic view results in an efficient solution for anticipating potential collisions with the workplace environment or with other workpieces.

FIG. 4 in this context is a flow chart showing the procedure of the inventive approach in one configuration.

Assuming, in particular, that the workpieces are supplied on the load carrier with an appropriate stacking precision, this approach will be sufficient for fully automizing the loading process.

Assuming, on the other hand, that the workpieces are not supplied with sufficient stacking precision, the offset of the workpieces can be recognized by means of a search for the predefined color image segment in the orthographic view of a current captured image and/or can be based on an updated sensor signal. The relative location of the grasping point and its orientation on the component may then be used to determine a new grasping point. It is equally possible to create mesh files of the components through the orthographic view. The corresponding process workflow is schematically represented in FIG. 5.

The mesh model used in searching for the workpiece in new captured images (updated sensor signal) may also be employed in the context of an unloading process in which another loading robot is provided in the unloading zone. When comparatively thin sheet metal parts are processed or when the position of the camera is vertically above the pallet and/or above the conveyor belt, it may in certain cases be sufficient to use a 2D model of the workpiece.

FIG. 6 represents a further optional complement. By affixing fixed-position markings relative to the loading robot, the camera can be placed anywhere, as shown in FIG. 6

FIG. 7 schematically represents a method according to the invention for loading or unloading a sheet metal processing machine or a wood working machine. The method comprises the steps of: receiving S10 a sensor signal, creating S12 a representation of the workpiece, providing S14 said representation, receiving S16 a user input, determining S18 a revised representation, providing S20 the revised representation, receiving S22 a further user input, determining S24 control instructions, and activating and controlling S26 the loading robot. The process can, for example, be implemented in software that is executed on a machine system of a sheet metal processing machine.

The invention has been comprehensively described and explained with reference to the drawings and to the description. The description and the explanation are to be understood as exemplary and not restrictive. The invention is not limited to the disclosed embodiments. Other embodiments or variations will become apparent to those skilled in the art when using the present invention and when thoroughly analyzing the drawings, the disclosure, and the following claims.

In the claims, the words “comprising” and “with/having” do not exclude the presence of further elements or steps. The indefinite article “a” or “an” used in connection with a word does not exclude the existence of a plurality of the items in question. A single element or a single unit can perform the functions of several of the units mentioned in the patent claims. An element, a unit, a device and a system can be partially or fully implemented in hardware and/or in software. The mere mention of some measures in several different dependent patent claims is not to be understood as meaning that a combination of these measures cannot also be used advantageously. A computer program can be stored/distributed on a non-volatile data carrier, for example on an optical memory or on a solid-state drive (SSD). A computer program can be distributed together with hardware and/or as part of hardware, for example via the Internet or through wired or wireless communication systems. Reference signs in the patent claims are not to be understood restrictively.

1. A device for loading or unloading a sheet metal processing machine or a wood working machine, including:
a sensor interface for receiving a sensor signal comprising information on workpieces present in a loading area of the sheet metal processing machine or wood working machine;
a representation unit for creating a representation of the workpieces and of the loading area, based on the sensor signal;
a user interface for providing said representation to a machine operator and for receiving a user input from the machine operator comprising information on a position of the workpieces in the representation;
an evaluation unit for determining a revised representation of the workpieces and the loading area, based on the sensor signal and on the user input, the user interface being designed for providing said revised representation to the machine operator and for receiving a further user input comprising information on a workpiece loading operation to be carried out;
a planning unit for determining control instructions enabling a loading robot to execute the loading operation to be carried out based on the sensor signal and on said further user input; and
a control interface for activating and controlling the loading robot to execute the loading operation based on the control instructions.

2. The device as claimed in claim 1, wherein the sensor interface is designed for receiving a sensor signal related to a color image and to a depth image of the workpieces present in the loading area.

3. The device as claimed in claim 1, wherein the representation unit is designed for creating an image representation.

4. The device as claimed in claim 1, wherein the user interface comprises a display.

5. The device as claimed in claim 1, wherein the user interface is designed for receiving a further user input comprising at least one of
a position of a grasping point for the loading robot on the workpiece;
a depositing position of the workpiece; and/or
an orientation of the workpiece when it is being deposited.

6. The device as claimed in claim 1, wherein the evaluation unit is designed for at least one of
determining a surface plane of a workpiece based on a segmentation and based on a user input and
determining an orthographic view.

7. The device as claimed in claim 1, wherein the planning unit is designed for determining control instructions comprising grasping coordinates and depositing coordinates of the workpiece.

8. The device as claimed in claim 1, wherein the planning unit is designed for determining the control instructions based on at least one of
predefined path default data for the movement of the loading robot related to the loading area; and
predefined sensor position data for the position of the sensor related to the loading area.

9. The device as claimed in claim 1, wherein the user interface is designed for receiving a user input comprising a thickness of the workpieces.

10. The device as claimed in claim 1, wherein
the user interface is designed for receiving a user input comprising information on a position of workpieces that are located in the representation in an uppermost one of a plurality of layers of workpieces;
the planning unit is designed for recognizing an offset of a workpiece located in a second layer, subsequent to a loading operation of a workpiece placed in a first layer; and
the planning unit is designed for determining the control instructions on the basis of the offset.

11. A system for loading or unloading a sheet metal processing machine or a wood working machine, including:
a device as claimed in claim 1;
a sensor for covering the loading area; and
a loading robot for executing the loading operation based on the control instructions.

12. The system as claimed in claim 11, wherein the sensor comprises at least one of a color camera and/or a depth camera directed towards a loading area of the sheet metal processing machine or the wood working machine.

13. The system as claimed in claim 11, wherein the loading robot is designed for executing a loading operation and the sensor is designed for covering a loading zone, including:
another loading robot for carrying out an unloading operation; and
another sensor for covering an unloading zone and for providing a sensor signal comprising information on workpieces present in the unloading zone, wherein
the planning unit is designed for determining control instructions enabling the other loading robot to execute an unloading operation to be carried out based on the sensor signal, on said further sensor signal, and on said further user input; and
the control interface is designed for activating and controlling the other loading robot to execute the unloading operation based on the control instructions.

14. A method for loading or unloading a sheet metal processing machine or a wood working machine, including the steps of:
receiving a sensor signal comprising information on workpieces present in a loading area of the sheet metal processing machine or wood working machine;
creating a representation of the workpieces and of the loading area, based on the sensor signal;
providing the representation to a machine operator (28);
receiving a user input from the machine operator comprising information on a position of the workpieces in the representation;
creating a revised representation of the workpieces and of the loading area, based on the sensor signal and on the user input;
providing the revised representation to the machine operator;
receiving a further user input providing information on a loading operation of the workpiece that is to be carried out;
determining control instructions enabling a loading robot to execute the loading operation to be carried out based on the sensor signal and on said further user input; and
activating and controlling the loading robot to execute the loading operation based on the control instructions.

15. A computer program product including program code for carrying out the steps of the method as claimed in claim 14 when the program code is being executed on a computer.

16. The device as claimed in claim 8, wherein at least one of the path default data and the sensor position data have been determined in the course of a calibration process.

17. The device as claimed in claim 4, wherein the user interface comprises a touchscreen display.

18. The device as claimed in claim 6, wherein the evaluation unit is designed for determining a surface plane of a workpiece based on a segmentation and based on a user input by employing a RANSAC algorithm.

19. The system as claimed in claim 11, wherein the loading robot is an industrial robot having a manipulator arm.
